(19) United States
(12) Patent Application Publication
(10) Pub. No.: US 2026/0330810 A1
(43) Pub. Date: Oct. 22, 2026

(54) INCREMENTAL ITEM RECOGNITION MODEL TRAINING USING MULTI-VIEW IMAGE DATA

(71) Applicant: Walmart Apollo, LLC, Bentonville, AR (US)

(72) Inventors: Xin Ma, Arlington, TX (US); Wei Wang, Dallas, TX (US); Han Zhang, Allen, TX (US); Raghava Balusu, Achanta (IN); Abhinav Pachauri, Bangalore (IN); Huanyu Zang, Frisco, TX (US); Avinash M. Jade, Bangalore (IN); Mingquan Yuan, Flower Mound, TX (US); Lingfeng Zhang, Flower Mound, TX (US); William Craig Robinson, Centerton, AR (US); Feiyun Zhu, Plano, TX (US); Zhaoliang Duan, Frisco, TX (US)

(21) Appl. No.: 19/184,088

(22) Filed: Apr. 21, 2025

(51) Int. Cl. G06V 10/774; G06V 10/12; G06V 10/32; G06V 10/764

(52) U.S. Cl. CPC G06V 10/774; G06V 10/12; G06V 10/32; G06V 10/764

(57) ABSTRACT

Examples provide incremental item recognition model training using multi-view image data including top and bottom view images of items. The top view images are generated by camera(s) mounted to a top portion of a support structure and bottom view images are generated by camera(s) mounted to a bottom portion of the archway truss device. Images of high impact items are used to train the model initially. Images of other lower impact items are used to progressively train the model in subsequent training epochs. Data augmentation and image resizing with down-sampling and over-sampling is used to create uniform image sizes and balanced item class distribution. Performance metrics are applied to historical item data to identify highest impact items. The dual-view image data is used to iteratively train a computer vision item recognition model to more accurately detect and recognize items appearing in images generated by the cameras on the archway truss.

### BACKGROUND

Computer vision (CV) item detection and recognition machine learning (ML) models can be used to automatically identify objects of interest appearing in images without human intervention. These models are trained to detect and recognize specific types of objects and/or classify objects within images using labeled training data associated with image datasets corresponding to the objects of interest. Managing image datasets, which can include millions of images of thousands of different items having one or more unique product codes (UPCs) associated with each item, poses significant logistical and computational challenges. In many cases, available image datasets include highly disproportionate distribution of images across different classes with large numbers of images of some objects and relatively few images of other objects. Disproportionate distribution of images for each object of interest can result in inconsistent model training degrading overall model accuracy and favoring classes with greater data representation. This can further contribute to mislabeling, overlapping categorization of identical products under different UPCs, inaccurate item recognition predictions, and inaccurate classification of identical or near identical items rendering CV ML model predictions unreliable.

### SUMMARY

Some examples provide a system and method for item recognition model training with dual-view image data. Dual-view image data associated with a plurality of items is obtained. The dual-view image data includes a plurality of images generated by a plurality of image capture devices. The dual-view image data comprising top view images generated by a first image capture device and bottom view images generated by a second image capture device. A set of one or more high impact items is selected from the plurality of items using a set of configurable performance criteria. The dual-view image data is filtered to extract a subset of the dual-view image data associated with the set of high impact items. The subset of the dual-view image data comprising a set of top view images of each item in the set of high impact items and a set of bottom view images of each item in the set of high impact items. A first set of training data having a higher ratio of top view images of the set of high impact items is generated. A second set of training data having a higher ratio of bottom view images of the set of high impact items is generated. The item recognition model is trained in a multi-phased approach using the first set of training data during a first training phase and the second set of training data during a second training phase. The trained item recognition model automatically identifies an item identifier (ID) associated with each high impact item in the set of high impact items appearing in images generated by the plurality of image capture devices with greater accuracy.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for incrementally training item recognition models using multi-view image data with balanced item class distributions.

FIG. 2 is an exemplary block diagram illustrating a training manager for creating training data with multi-view images and balanced item class distributions.

FIG. 3 is an exemplar block diagram illustrating a support structure for supporting a plurality of image capture devices generating multi-view image data for a plurality of items.

FIG. 4 is an exemplary block diagram illustrating an archway truss supporting two or more image capture devices.

FIG. 5 is an exemplary block diagram illustrating a multi-lane archway truss device supporting multiple image capture devices.

FIG. 6 is an exemplary flow chart illustrating operation of the computing device to incrementally train an item recognition model.

FIG. 7 is an exemplary flow chart illustrating operation of the computing device to identify high impact items using configurable performance metrics.

FIG. 8 is an exemplary flow chart illustrating operation of the computing device to perform multi-phase training of an item recognition model using multi-view image data.

FIG. 9 is an exemplary flow chart illustrating operation of the computing device to incrementally train an item recognition model focusing on high impact item classes.

FIG. 10 is an exemplary flow chart illustrating operation of the computing device to balance item class representation in image data.

FIG. 11 is an exemplary diagram illustrating a training process for incrementally training an item recognition model using multi-view image data.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Managing an image dataset having millions of images of items associated with thousands of unique product codes (UPCs) poses significant logistical and computational challenges in data handling and processing. Class imbalance frequently occurs due to highly disproportionate distribution of images across different classes, compromising training consistency and degrading overall model accuracy, favoring classes with more data representation. Class overlap and noise associated with images results in frequent mislabeling and overlapping categorization of identical products under different UPCs. This further contributes to confusion in model predictions, making it difficult to achieve high accuracy in classifying similar or identical items.

Referring to the figures, examples of the disclosure enable more accurate item image detection and recognition by using multi-view image data with balanced item class distributions. In some embodiments, the system utilizes dual-view image data including top views and bottom views. The system in other embodiments includes multi-view images having top and bottom views, optionally extendable to additional views such as side or angled views.

In some examples, the system enables incremental training of computer vision item recognition machine learning models using multi-view image data with balanced item class distribution. The multi-view image data and balanced class distribution enables improved model training for more accurate item recognition with improved efficiency and reduced error rate.

Some aspects of the embodiments enable training of item recognition models incrementally by utilizing a multi-phased training method. An item recognition model a computer vision model trained to extract visual embeddings and identify items through similarity-based classification. The model training initially focuses on subsets of items and/or item IDs selected based on recent sales data and classification performance to minimize class overlap, thereby enhancing training adaptability and efficiency.

Some embodiments provide dual-view image utilization. The system utilizes top-view and bottom-view images differentially during the training process to improve the model's robustness and adaptability to variable image qualities and lighting conditions.

Other embodiments provide dynamic class addition during model training and fine-tuning. The system implements a progressive class inclusion system, where new classes are added based on their performance metrics, ensuring continuous enhancement of model performance and adaptability to store inventory changes.

The computing device operates in an unconventional manner by generating multi-view image-based training data with balanced class distribution for use in training a model in multiple phases focusing on different image views for improved model training and greater item recognition accuracy for all classes of items represented in the training data. In this manner, the computing device is used in an unconventional way, and allows improve item detection with decreased error rate in item identification (ID) for items appearing in images analyzed by the trained item recognition model, thereby improving accuracy of the item recognition results as well as improving the functioning of the underlying computing device with reduced error rate when assigning an item identifier to an item appearing in an image.

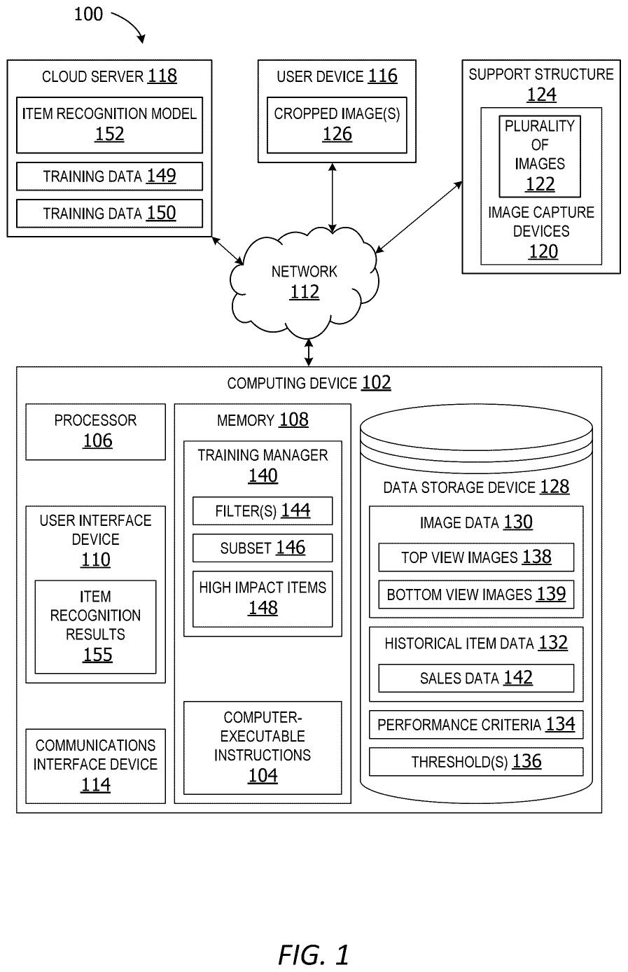

Referring again to FIG. 1, an exemplary block diagram illustrates a system 100 for incrementally training item recognition models using multi-view image data with balanced item class distributions. The item recognition model is a computer vision (CV) model trained to extract visual embeddings and identify items through similarity-based classification. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

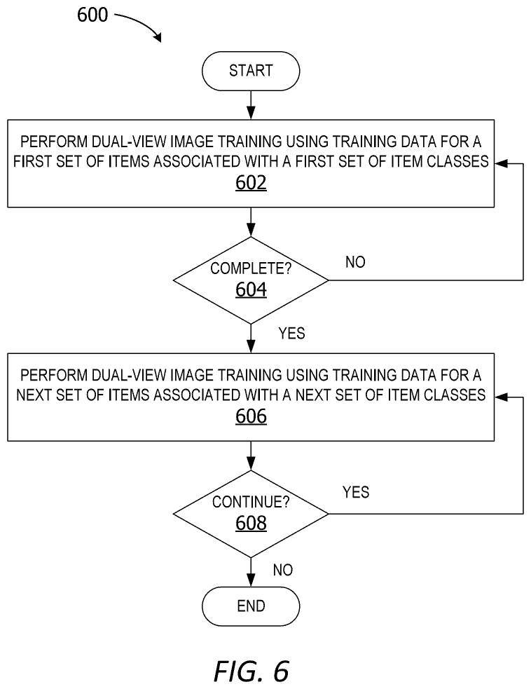

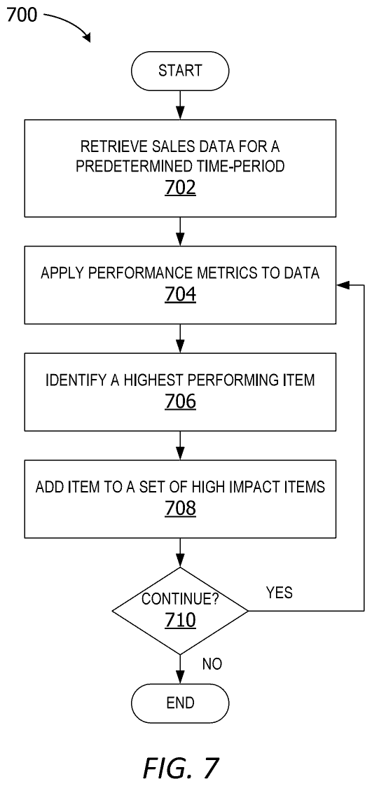

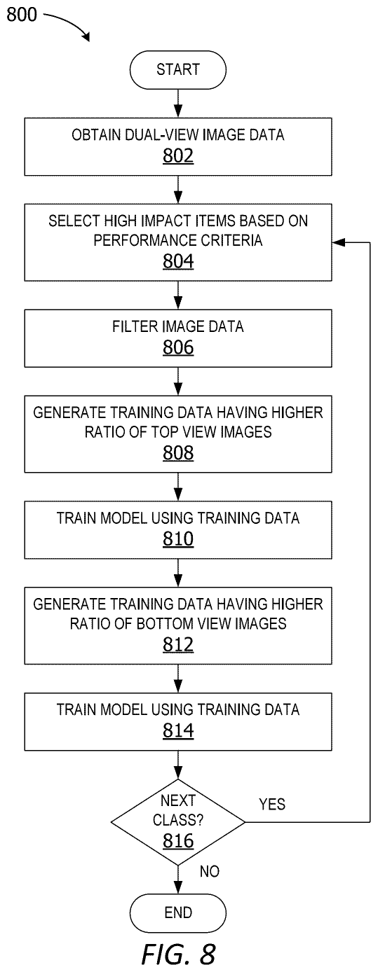

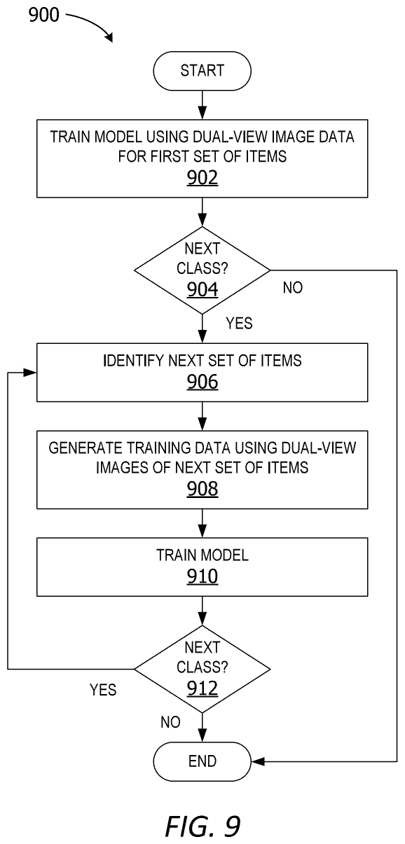

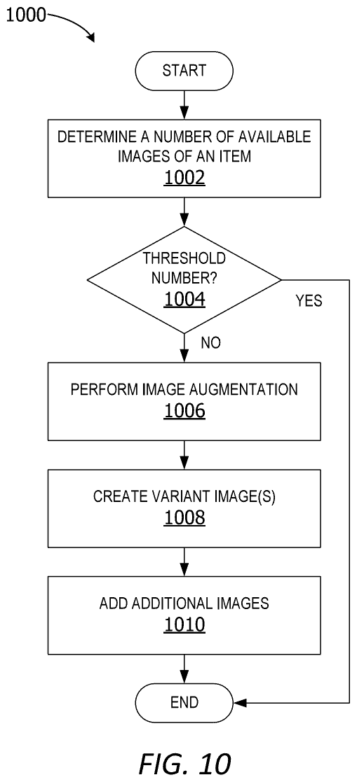

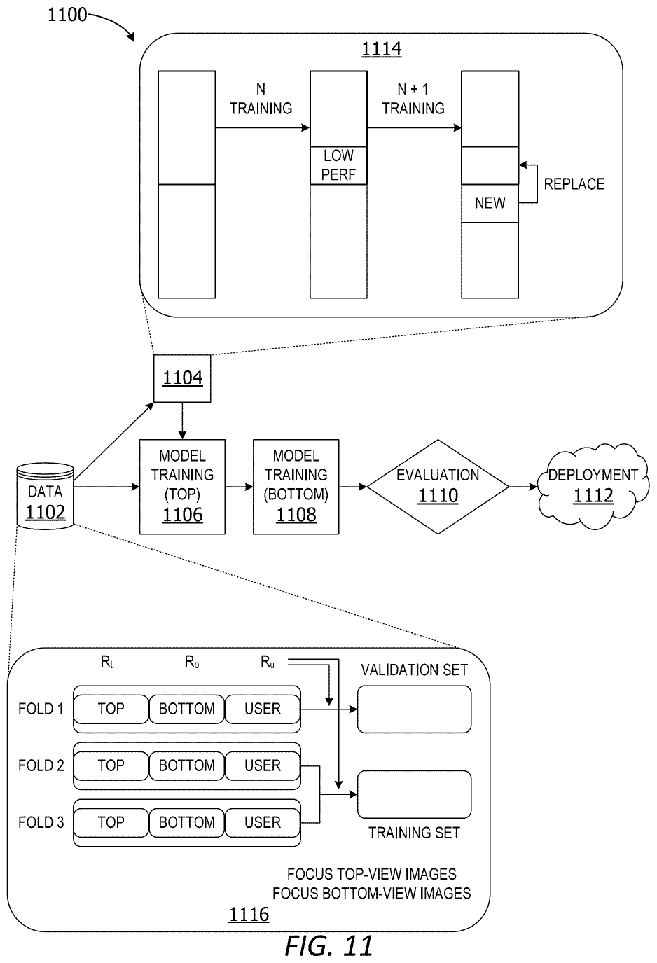

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, FIG. 8, FIG. 9, FIG. 10, and FIG. 11).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, a cloud server 118, and/or one or more image capture devices in a plurality of image capture devices 120, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

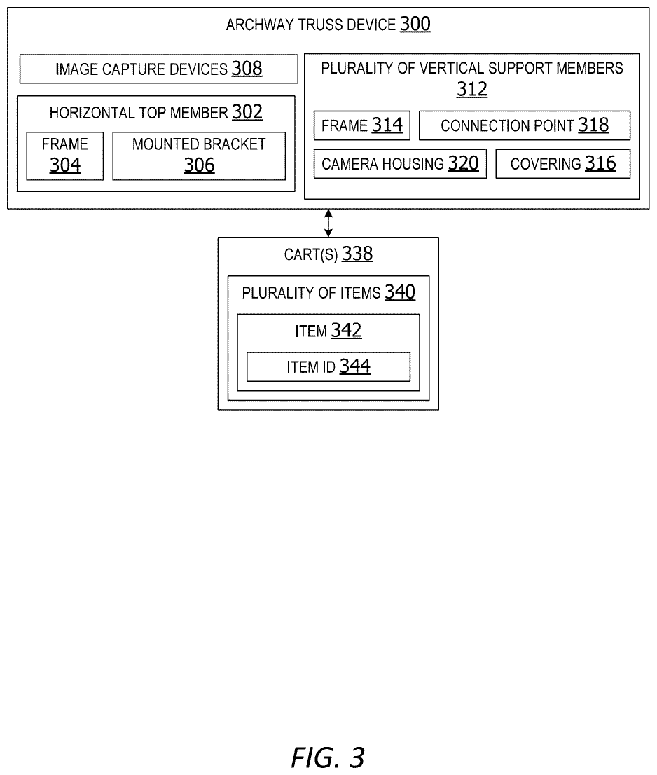

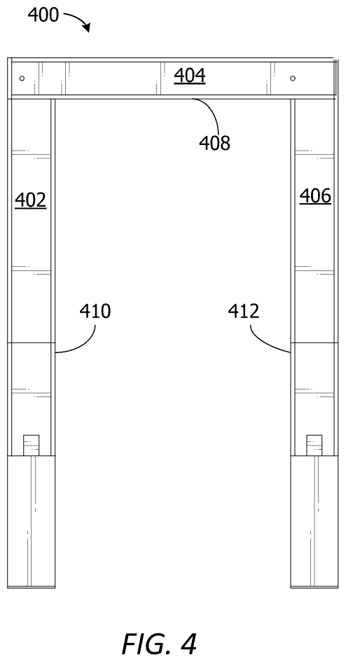

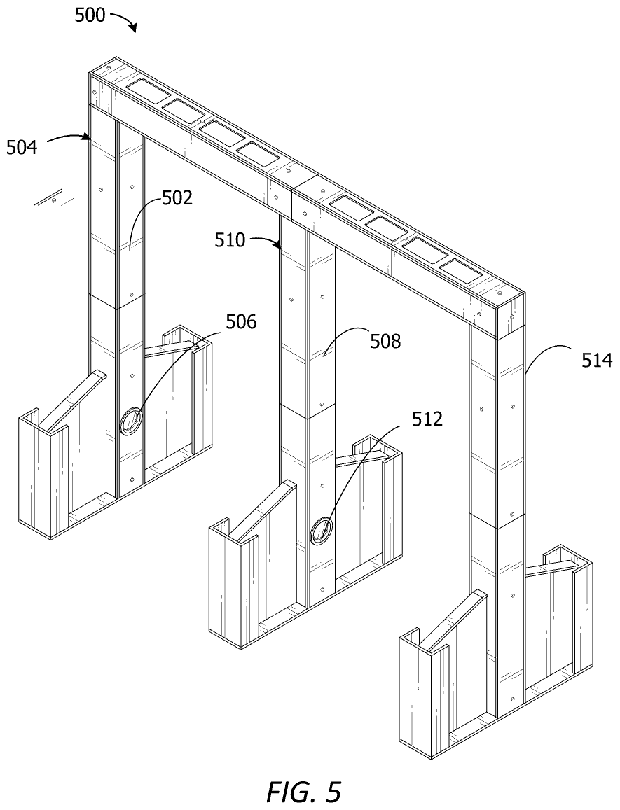

The plurality of image capture devices 120 includes one or more image capture devices, such as, but not limited to, a camera. The plurality of image capture devices 120 generates a plurality of images 122 having two or more different image views. The plurality of image capture devices 120 includes two or more cameras mounted to a support structure 124, such as, but not limited to, an archway truss device as shown in FIG. 3, FIG. 4, and FIG. 5 below. The plurality of images 122 include color images. In other embodiments, the plurality of images 122 includes black-and-white images.

In this example, the plurality of image capture devices 120 are mounted to the stationary support structure 124. In other embodiments, one or more image capture devices are mounted on an unmanned vehicle, such as a mobile robotic device capable of moving throughout an interior or exterior space and capturing images of objects of interest. An unmanned vehicle includes a vehicle having wheels for rolling on the ground, as well as aerial drone vehicles capable of flight for capturing birds-eye-view images of objects from above.

In other embodiments, a handheld image capture device or an image capture device included within the user device 116 is used to capture images and/or edit or crop images. The cropped image(s) 126 include images cropped to remove noise and other objects which are not of interest in order to isolate a single item within each cropped image. The user device 116 can be used to crop images generated on the user device 116 and/or to edit or crop images generated by a camera which is not part of the user device. For example, the user device 116 can be used to edit one or more of the plurality of images 122 generated by the plurality of image capture devices 120 on the support structure 124, cameras mounted on an unmanned vehicle, or any other type of device.

The system 100 can optionally include a data storage device 128 for storing data, such as, but not limited to image data 130, historical item data 132, performance criteria 134, and/or threshold(s) 136. The image data 130 is multi-view image data. Multi-view image data includes data associated with multiple images captured from two or more different image capture devices such that the images depict two or more different image views of the same item or other object. In this example, the image data 130 includes two image views, a top view and bottom view. However, in other embodiments, the image data can include three or more different views, such as top view, side view, bottom view, angled view, front view, back view, etc.

For example, a camera mounted to a top portion of the support structure 124 and focused downward to capture images of objects on the ground beneath the support structure captures birds-eye-view type or top view images 138. A camera mounted to a side or bottom portion of the support structure and positioned to capture images of the sides of objects passing through the support structure or passing next to the support structure generates bottom view images 139. In this example, the image data 130 includes image data for images that include top view images 138 and bottom view images 139 of a plurality of different items in a plurality of different classes.

Historical item data 132 includes data associated with a plurality of different items during a predetermined time-period. In this example, the predetermined time-period is a two week period. However, the examples are not limited to a two week period. The predetermined time period can include any amount of time, such as, but not limited to, a twenty-four hour period, a month, a year, a forty-eight hour period, a five year period, a one week period, or any other user-configurable amount of time. The historical item data 132 includes historical data for one or more items, such as, but not limited to, sales data 142, cost data, turnover rates, profit margin, trends data, seasonality data, or any other type of data associated with the plurality of items.

The sales data 142 is data associated with the purchase and/or sale of one or more items. The sales data 142 includes data such as, but not limited to, number of items sold within a predetermined time-period, price, discounts, promotions, sales volume, number of units or cases sold, item-outs, etc. In this example, the sales data 142 includes the number of instances of each type of item sold within the predetermined time-period.

Performance criteria 134 includes the one or more criteria for assessing performance of an item. The performance criteria 134 can also be referred to as performance metrics. Performance criteria 134 are applied to determine which items are the highest impact items. A high impact item is an item that has high performance based on application of the performance criteria to the item data. For example, if performance criteria 134 is applied to sales data 142 to identify items sold at the highest volume or highest number of instances of the items. Thus, a high impact item is an item that is selected because it has higher sales or greater popularity than other items.

The embodiments are not limited to high impact items which have the highest sales. High impact items, in other embodiments, can include promotional items, newest items added to an item assortment, highest demand items, etc. High impact items satisfy one or more performance criteria determined by applying one or more performance metrics to item data, such as sales data, etc. This could also include items which meet or exceed certain performance threshold(s) 136, such as a threshold minimum value, a threshold minimum sales, etc.

The data storage device 128 can include one or more different types of data storage devices, such as, for example, one or more rotating disks drives, one or more solid state drives (SSDs), and/or any other type of data storage device. The data storage device 128 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks, a flash memory drive, a storage area network (SAN), or other data storage device. In other examples, the data storage device 128 includes a database.

The data storage device 128 in this example is included within the computing device 102, attached to the computing device, plugged into the computing device, or otherwise associated with the computing device 102. In other examples, the data storage device 128 includes a remote data storage accessed by the computing device via the network 112, such as a remote data storage device, a data storage in a remote data center, or a cloud storage.

The memory 108 in some examples stores one or more computer-executable components, such as the training manager 140. The training manager 140 component, when executed by the processor 106 of the computing device 102, obtains the image data 130 associated with a plurality of items, such as, but not limited to, the plurality of items 340 in FIG. 3. The dual-view image data includes the plurality of images 122 generated by the plurality of image capture devices 120. The image data 130 includes top view images 138 generated by a first image capture device mounted at a position at or near a top portion of the support structure 124. The image data 130 includes bottom view images 139 generated by a second image capture device located at or near a bottom portion of the support structure 124.

The training manager 140, in some embodiments, selects a set of one or more high impact items 148 from the plurality of items using a set of one or more configurable performance criteria 134. A high impact item is an item having a high performance or high ranking based on the applied performance criteria. For example, if the performance criteria is sales volume within a predetermined time period, the items are ranked in accordance with the amount of sales for each item. The items with the highest sales are ranked highest. The highest ranked item is the highest impact item in this example. However, if the performance criteria is associated with trending items, such as clicks and views on an application or website, a high impact item can be an item having the highest number of clicks and/or views instead of being based solely on number of actual sales.

The set of high impact items can include any number of items. For example, the set of high impact items can include a single item, a hundred items, two thousand items, three thousand items, or any other number of items. In some examples, a configurable threshold value is used to determine the number of items to include in the set of high impact items.

The training manager 140 applies one or more filter(s) 144 the image data 130. In other words, the training manager filters the image data 130 to extract a subset 146 of the dual-view image data associated with the set of high impact items, the subset of the dual-view image data comprising a set of top view images of each item in the set of high impact items and a set of bottom view images of each item in the set of high impact items 148. In this example, the filter is a performance based filter for identifying images associated with high impact items.

In some embodiments, the training manager 140 generates a first set of training data 149 having a higher ratio of top view images of the set of high impact items and a second set of training data 150 having a higher ratio of bottom view images of the set of high impact items. An item recognition model 152 is trained using the first set of training data 149 during a first training phase and the second set of training data 150 during a second training phase. The item recognition model 152 creates an embedding of the image and compares the embedding with the embedding of a target item. Using similarity scoring, the item recognition model is able to identify the item based on which target item is most similar to the item in the cropped image. In some embodiments, the trained item recognition model 152 automatically identifies an item and assigns an item ID to each item in the set of high impact items appearing in images generated by the plurality of image capture devices with greater accuracy.

In this example, the training manager 140 is depicted on a computing device 102 while the item recognition model 152 is depicted on a cloud server 118. In other embodiments, both the training manager 140 and the item recognition model 152 are located on the computing device 102. In still other embodiments, the training manager 140 and the item recognition model 152 are both located on the cloud server 118. In still other embodiments, the training manager 140 is incorporated within the item recognition model such that the training manager 140 continuously trains and re-trains the item recognition model 152 as part of the item recognition model operations. In other words, the system for training and re-training (fine-tuning) the item recognition model 152 is incorporated within the model for continuous updating and fine-tuning.

In still other embodiments, the training manager 140 obtains feedback from a user and/or from other systems which is used to further refine and fine-tune the training manager 140 to improve accuracy of item recognition and efficiency in training the model. The feedback can be provided via the cloud server and/or the user device 116. The feedback can be provided periodically by users. The feedback, in other embodiments, includes performance-related feedback generated by the training manager 140 itself.

For example, if the item recognition model 152 fails to show expected improvement after performing training using the first set of training data 149 and/or the second set of training data 150, the performance data indicating lack of improvement in item recognition is used to further refine/improve selection of images and/or selection of high impact items for future training of the item recognition model. In this manner, the item recognition model 152 generates more accurate item recognition results 155. The item recognition results 155 include a predicted identification of one or more items appearing in one or more cropped image(s) 126 input into the trained item recognition model 152. In some embodiments, the item recognition results 155 includes a list of predicted UPCs for a given item appearing in one or more cropped images.

In some embodiments, the training manager 140 performs advanced data augmentation by implementing a random augmentation (RandAug) process to enhance the diversity and robustness of the image dataset and also deal with overfitting. Overfitting occurs where a model learns the training data too well, including its noise and outliers, which decreases accuracy and performance.

The training manager 140, in other embodiments, performs image standardization on the plurality of images. The training manager resizes the images to uniform dimensions. In one example, the images are resized to uniform dimensions of 224×224 pixels to ensure consistency across the dataset.

Balancing class distribution is performed by the training manager with down-sampling where there are too many images of a given item. The system performs over-sampling by augmenting images to create more variants of each image where there are too few images of a given item available for use in training data. Down-sampling reduces the number of images in overrepresented UPCs to prevent model bias. Over-sampling increases the representation of underrepresented UPCs to ensure adequate learning and improve model performance.

In still other embodiments, the system employs a dynamic learning rate scheduler that methodically reduces the learning rate during training epochs to fine-tune model weights and enhance convergence. Targeted Initial Training and progressive class expansion ensures more thorough and accurate training of the model. In some embodiments, model training begins with classes generating high sales, leveraging real-time sales data to prioritize learning on high-impact classes. The training manager systematically adds more image data for additional classes based on their performance metrics to incrementally boost the model's accuracy and adaptability. Image data associated with similar items, such as items that are the same, similar items, and/or items having duplicated UPCs, are removed to increase performance and training efficiency, which further reduces system resource usage.

In these embodiments, the images captured by the image capture devices are not intended to capture images of human users. Any images having human users or other objects which are not of interest inadvertently included within the images are removed from the images by cropping the images such that only objects of interest remain in the cropped images. Images of users or objects which are not of interest are deleted or otherwise discarded. The cropped images containing only the objects of interest are then analyzed to identify and label the objects of interest within the cropped images.

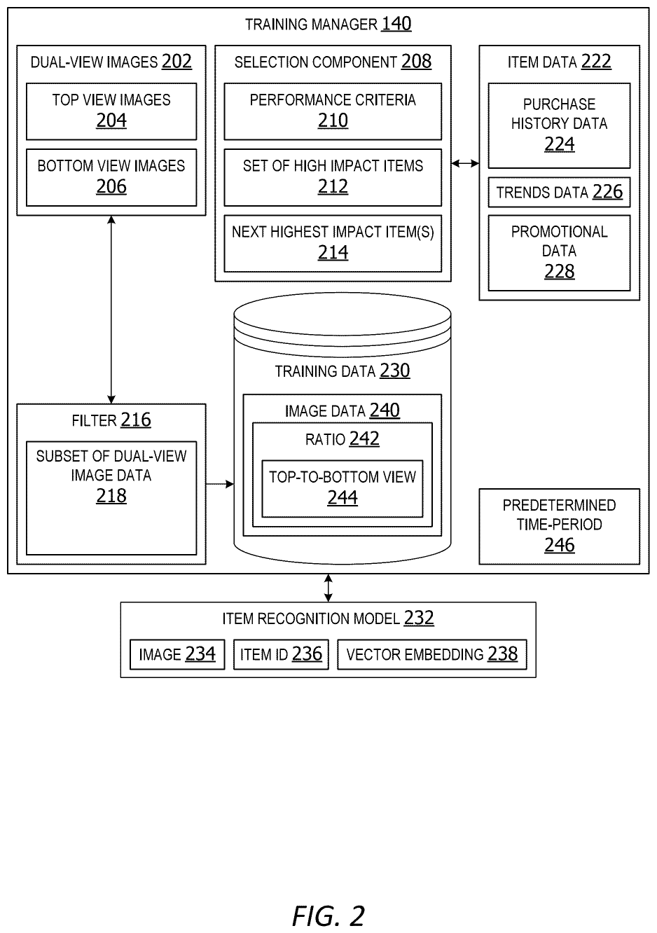

FIG. 2 is an exemplary block diagram illustrating a training manager 140 for creating training data with multi-view images and balanced item class distributions. The training manager 140 obtains dual-view images 202 from one or more image capture devices and/or retrieves the dual-view images 202 from a data storage device. The dual-view images 202 includes a plurality of top view images 204 generated by one or more image capture devices mounted at or near a top portion of a support structure. The dual-view images 202 includes bottom view images 206 of one or more items generated by one or more image capture devices mounted at or near a bottom portion of the support structure, such as, but not limited to, the support structure 124 in FIG. 1. The dual-view images 202 are images associated with dual-view image data, such as, but not limited to, the image data 130 in FIG. 1.

A selection component 208 applies performance criteria 210 to item data 222 to select a set of one or more high impact items 212. A high impact item is an item which meets certain performance criteria, such as high sales within a predetermined time-period. In this example, a high performance item is an item which is most likely to be encountered in an image captured by the image capture devices. In other words, high impact items tend to appear more frequently in the dual view images 202 which are analyzed by the item recognition model.

The item data 222 is data associated with one or more items. The item data optionally includes purchase history data 224, trends data 226, promotional data 228, and any other data associated with the item(s). The purchase history data 224, in this example, includes sales and purchase related data indicating the number of instances of each type of items sold within a predetermined 246 time-period. The trends data 226 is data associated with popular purchasing trends at a given store or at stores within a given geographic region. The promotional data 228 is data associated with discounts, promotions, special sale prices, etc.

A filter 216 is applied to filter out images which do not include the high impact item(s) in the set of high impact items 212. A subset of dual-view image data 218 is generated. The subset of dual-view image data 218 includes image data associated with images of the high impact items in the set of high impact items 212. The system creates training data 230 used to train an item recognition model 232. The item recognition model 232 is a CV model trained to identify objects of interest appearing in the image data associated with an image, such as, but not limited to, the item recognition model 152 in FIG. 1. In some embodiments, the item recognition model 232 extracts a vector embedding 238 associated with an image 234 and performs similarity scoring with target embeddings for known item images. The item recognition model 232 identifies the item and/or an item ID 236 for the item in the image. The item ID 236 can include any type of item identifier, such as, but not limited to, a UPC. The output of the item recognition model 232 in some embodiments is a list of predicted UPCs for an item appearing in one or more cropped images. In other words, the trained item recognition model generates a list of predicted UPCs or other item IDs for each item in a cropped image.

The training data 230 includes image data 240 having one or more top-to-bottom view 244 ratio 242. In some embodiments, a first set of image data having a ratio 242 which favors the top view images. In other words, the first set of training data includes a higher ratio of top view images than bottom view images for use in a first phase of training. A second set of image data is generated with a higher ratio of bottom view images then top view images. The second set of image data with the higher bottom view images ratio is used in the second phase of training.

After training the model using the first set of high impact items 212, the selection component generates a set of next highest impact item(s) 214. The next highest impact items do not include any other the items in the first set of high impact items 212. A second subset of dual-view image data having top view and bottom view image of the next highest impact items.

In other embodiments, the training manager 140 selects a set of next highest impact items from the plurality of items using the set of configurable performance criteria. The training manager 140 extracts a second subset of the dual-view image data associated with the set of next highest items. The second subset of the dual-view image data comprising dual-view images of each item in the set of next highest impact items, the dual-view images comprising top view images and bottom view images. The training manager 140 generates a third set of training data having the higher ratio of the top view images of the set of high impact items and a fourth set of training data having the higher ratio of bottom view images of the set of high impact items. The top view images typically are better quality images with less noise and fewer obstructions than the bottom view images. Bottom view images are more likely to include noise and other obstructions which can be blocking the camera view of the item of interest.

The training manager re-trains the item recognition model iteratively using the third set of training data during a third training phase and the fourth set of training data during a fourth training phase. The trained item recognition model automatically identifies item IDs associated with items in the set of high impact items and the set of next highest impact items appearing in images generated by the plurality of image capture devices with greater accuracy.

In other embodiments, the training manager 140 performs image augmentation on the cropped images used to create the training data. The training manager 140 selects a threshold number of images of each item from the available images which have been generated by the image capture devices and/or stored for later use in the data storage device. If there are not enough images of the item to reach the threshold number of images, the training manager uses image augmentation to create variants of the available images. In other words, if the threshold number of images is one-hundred images but there are only twenty images of the item available, the training manager performs image augmentation to create eighty additional variants of the available twenty images. The variants can be created by altering the angle of the item in the images, changing lighting in the images, rotate the image, adjust color, or other alterations to ensure the threshold number of images of the selected item is available.

FIG. 3 is an exemplar block diagram illustrating a support structure for supporting a plurality of image capture devices generating multi-view image data for a plurality of items. The archway truss device 300 is a support structure for supporting two or more image capture devices 308, such as, but not limited to, the support structure 124 in FIG. 1. The archway truss device 300, in this example, includes a horizontal top member 302. The horizontal top member 302 has a frame 304. The frame 304, in some embodiments, is a metal frame. However, the embodiments are not limited to a metal frame. In other embodiments, the frame 304 is composed of any other appropriate material.

The horizontal top member 302, in some embodiments, includes a mounting bracket 306 or other attachment device for removably attaching an image capture device.

The archway truss device 300 includes a plurality of vertical support members 312. In some embodiments, the plurality of vertical support members 312 includes two vertical support members defining a single lane of travel through the archway truss device 300. In these embodiments, two vertical support members are spaced a predetermined distance apart which is sufficient to enable at least one user pushing a shopping cart or driving a motorized cart to pass between the two vertical support members of the archway truss device 300 as the user proceeds toward the exit via the lane of travel between the two vertical support members.

In other embodiments, the plurality of vertical support members 312 includes three vertical support members defining two distinct lanes of travel through the archway truss device 300. In still other embodiments, the archway truss device 300 includes four vertical support members defining three lanes of travel through the archway truss device 300. In still other embodiments, the archway truss device 300 includes five or more vertical support members defining four or more lanes of travel through the archway truss device.

Each vertical support member in the plurality of vertical support members 312 includes a frame 314 and optionally includes a covering 316 over the frame. Each vertical support member connects to the horizontal top member 302 at a connection point 318. The connection point 318 is located at a top portion of each vertical support member.

A camera housing 320 is recessed within each vertical support member. The camera housing 320 is sized to encompass an image capture device, such as a camera.

The cameras mounted on the archway truss generate multi-view images of one or more cart(s) 338 containing a plurality of items 340 passing through or near the archway truss device 300. The plurality of items includes items such as, but not limited to, the item 342. The item 342 can include any type of item, such as, but not limited to, an item of apparel, comestible, footwear, hardware, tool, pet care product, or any other type of item. Each item is identified via an item ID 344, such as, but not limited to, an item UPC.

Referring now to FIG. 4, an exemplary block diagram illustrating an archway truss 400 supporting two or more image capture devices is shown. In this example, the archway truss is a single lane archway truss. The archway truss 400 is a support structure 124 for supporting a plurality of image capture devices, such as, but not limited to, the support structure 124 in FIG. 1 and/or archway truss device 300 in FIG. 3. In this example, a first vertical support member 402 is attached to a horizontal top member 404. A second vertical support member 406 is attached to the horizontal top member 404. In this example, the first vertical support member 402 and the second vertical support member 406 are spaced apart a pre-defined distance sufficient to enable a single user pushing a cart, carrying a basket, or riding in a motorized cart to pass through the archway between the vertical support members of the archway truss 400.

In this example, a top camera is attached to a portion 408 of the horizontal top member 404. The portion of the archway truss at which the top camera is mounted can be referred to as a top portion of the support structure. A first bottom camera is attached to a bottom portion 410 of the vertical support member 402. A second bottom camera is attached to a bottom portion 412 of the second vertical support member 406. Each camera captures images having a slightly different view. In this example, the top camera is positioned to capture images of items beneath the camera. The top camera captures images having a top view. The bottom cameras capture images of the sides of items. These images are referred to as having a bottom view or side view.

In this example, only two vertical support members are provided to create a single lane of travel through the archway truss. However, the embodiments are not limited to only two vertical support members. In other embodiments, the archway truss 400 includes three or more vertical support members, as shown in FIG. 5 below.

FIG. 5 is an exemplary block diagram illustrating a multi-lane archway truss device 500 supporting multiple image capture devices. In this example, the multi-lane archway truss device 500 includes three vertical support members with a horizontal top member forming two lanes or passageways through the archway. In some embodiments, the multi-lane archway truss device 500 includes one or more recessed camera housings within one or more vertical support members. In this example, an interior side 502 of a first vertical support member 504 includes a recessed camera housing 506. A camera is placed inside the recessed camera housing 506. The camera captures images of a side and/or bottom of a cart, such as a shopping cart, motorized cart or basket carried by a user moving through a first lane defined by the first vertical support member 504 and the central support member 510.

Likewise, an interior side 508 of the central support member 510 also includes another recessed camera housing 512 for a camera. The camera inside the recessed camera housing 512 captures images of a side and/or bottom of a cart moving through the second lane defined by the central support member 510 and a second vertical support member 514.

In other embodiments, the central support member 510 includes two recessed camera housings. The recessed camera housing 512 is located on a first side of the central support member 510 facing toward the second vertical support member 514, such that the camera in the recessed camera housing can capture images of objects in the second lane. A second recessed camera housing (not shown) is located on an opposite side of the central support member facing toward the first vertical support member 504 sch that a camera in the second recessed camera housing can capture images of objects moving through the first lane.

FIG. 6 is an exemplary flow chart illustrating operation of the computing device to incrementally train an item recognition model. The process 600 shown in FIG. 6 is performed by a training manager component, executing on a computing device, such as the computing device 102 or the user device 116 in FIG. 1.

The process begins by performing dual-view image training using training data for a first set of items associated with a first set of item classes at 602. This training includes two phases in which one set of image data with a higher ratio of top view images is used and a second set of image data is used with a higher ratio of bottom view images is used. A determination is made whether the training is completed at 604. If yes, the system performs dual-view image training using training data for a next set of items associated with a next set of items classes at 606. A determination is made whether to continue at 608. If yes, a next set of items are selected, and training continues iteratively until a determination is made not to continue at 708. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to identify high impact items using configurable performance metrics. The process 700 shown in FIG. 7 is performed by a training manager component, executing on a computing device, such as the computing device 102 or the user device 116 in FIG. 1.

The process begins by retrieving sales data for a predetermined time-period at 702. Performance metrics are applied to item data at 704. A highest performing item is identified at 706. In this example, a highest performing item is an item having the highest sales within a given time-period. The highest impact item is added to a set of high impact items at 708. The set of high impact items can include a single item as well as two or more items. A determination is made whether to continue at 710. If yes, the process iteratively executes operations 704 through 708 to add additional high performing items to the set of high impact items until a determination is made not to continue. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to perform multi-phase training of an item recognition model using multi-view image data. The process 800 shown in FIG. 8 is performed by a training manager component, executing on a computing device, such as the computing device 102 or the user device 116 in FIG. 1.

The process begins by obtaining dual-view image data at 802. The dual-view image data is data associated with dual view images, such as, but not limited to, the image data 130 in FIG. 1. High impact items are selected based on performance criteria at 804. Image data is filtered at 806 to remove image data associated with items excluded from the set of high impact items. Training data is generated having a higher ratio of top view images at 808. An item recognition model is trained using the training data at 810. This is a first phase of training associated with the set of high impact items. Training data is generated having a higher ratio of bottom view images at 812. The higher ratio of bottom view images indicates the image data includes more images of the high impact items captured by cameras mounted to a bottom portion of the support structure rather than images generated by top cameras mounted to a top portion of the support structure. The item recognition model is trained using the training data having the higher ratio of bottom view images at 814. A determination is made whether another class of items remains for use in training the model at 816. If yes, the process continues iteratively executing operations 804 through 816 until no additional classes of items remain at 816. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

Turning now to FIG. 9, an exemplary flow chart illustrating operation of the computing device to incrementally train an item recognition model focusing on high impact item classes is shown. The process 900 shown in FIG. 9 is performed by a training manager component, executing on a computing device, such as the computing device 102 or the user device 116 in FIG. 1.

The process begins by training an item recognition model using dual-view image data for a first set of items at 902. In this examples, the first set of items is a set of highest impact items. A determination is made whether another class of items remains at 904. If not, the process terminates thereafter.

If an additional class of items remains, a next set of items is identified at 906. Training data is generated using dual-view images of items in the next set of items at 908. The model is trained at 910 using the training data. A determination is made whether a next class of items remains which has not been used to train the model at 912. If yes, the process iteratively executes operations 906 through 912 until no additional classes of items remain. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an exemplary flow chart illustrating operation of the computing device to balance item class representation in image data. The process 1000 shown in FIG. 10 is performed by a training manager component, executing on a computing device, such as the computing device 102 or the user device 116 in FIG. 1.

The process begins by determining a number of available images of an item at 1002. A determination is made whether a threshold number of items is available at 1004. If yes, the process terminates thereafter.

If the threshold number of item images is unavailable, image augmentation is performed on the available images at 1006. Variant image(s) are created at 1008. Variant images include images having different angles, different lighting, etc. The additional images are added to the available images at 1010. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

FIG. 11 is an exemplary diagram 1100 illustrating a training process for incrementally training an item recognition model using multi-view image data. In this example, multi-view images of a plurality of items is stored on a data storage device 1102. The data storage device is a device such as, but not limited to, the data storage device 128 in FIG. 1. The multi-view image data is used to train an item detection model in a multi-phase training process in which the model is trained using training data having a higher ratio of top view images at 1106. The model is trained during a second phase in which training data is used having a higher ratio of bottom view images at 1108. The model is evaluated at 1110 after training is complete. If the evaluation results indicate the model is performing correctly, deployment of the model occurs at 1112.

In some embodiments, the training data is generated during a process 1114 replacing low performance training data with new training data that has includes multi-view images that are balanced in regard to the distribution of classes such that each item has a sufficient amount of training images. If an item is overrepresented in the image data, down-sampling occurs to reduce or filter out superfluous images, such as duplicate images. If an insufficient number of images of an item exists in the training data, image augmentation is used to increase the number of images representing each item for which the model is being trained to recognize. In this manner, labeled training data including at least one item UPC for each item in generated at 1104.

The system obtains images from one or more image capture devices at 1102. The images are stored in the data storage device 1102. The images include top view images from one or more top view cameras, bottom view images from one or more bottom view cameras, and images uploaded from a user via a computing device, such as, but not limited to, the user device 116 and/or the computing device 102 in FIG. 1. The images are used for validation of the item recognition model results and/or to generate training data.

During a first phase of training, the item recognition model is trained using image data containing a higher ratio of top view images at 1116. For example, the training data can include eighty percent top view images, ten percent bottom view images, and ten percent user-provided images. During the second phase of training, shown at 1116, the model is trained using training data that includes a higher ratio of bottom view images. In other words, the training data includes more bottom view images than top view images. In this example, the ratio of top view images during the first phase of training includes the following: 0.8; 0.1; and 0.1. In other words, there are about eighty percent top view images, ten percent bottom view images, and about ten percent user-provided images. During the second phase, the ratios focusing on the bottom view images are as follows: 0.2; 0.6; and 0.2. In other words, there are about twenty percent top view images, sixty percent bottom view images, and twenty percent user-provided images.

However, the embodiments are not limited to these ratios. In other embodiments, any ratio of top view images, bottom view images and/or user-provided images may be used. Likewise, in still other embodiments, the system may employ only top view images and bottom view images without any user-provided images. In still other embodiments, the system may utilize additional views of items. For example, the system could include top view images from a top camera, bottom view images from one or more bottom cameras, as well as floor-view images from a camera at floor level angled upward towards a cart or other items. The multi-view image data could also optionally include top angled view images from a camera mounted above a cart or other items and directed downward at an angle rather than being mounted directly above a path taken by a cart or images having any other view of the items.

The labeled training data is used to train the model iteratively for each set of items. In other words, the model is not trained with all possible items at once. Instead, the model is trained with one subset of items at a time. As training for a first subset of items is completed, the system then selects a next subset of items for which the model will be trained until the model is trained to recognize all items in a given assortment or catalog of items. In some examples, the assortment of items are classified in different classes or categories. Each class represents one or more items. The model is trained on one class of items and then trained on the next class of items.

In other embodiments, the system selects the highest impact items in a given item assortment. The item recognition model is trained on the subset of items that includes the highest impact items. Once training on the highest impact items is completed, the system selects the next highest impact items remaining in the assortment. The model is then trained again using training data for the next subset of items including the next highest impact items. This process is performed iteratively until the model is trained on all the items and/or all the classes of items in the assortment.

### Additional Examples

In some examples, the system enables advanced data augmentation to enhance the diversity and robustness of the image dataset and also deal with overfitting. The system performs image standardization and balances class distribution using both down-sampling and oversampling to prevent model bias. A dynamic learning rate scheduler methodically reduces the learning rate during training epochs to fine-tune model weights and enhance convergence. The model is trained incrementally leveraging real-time sales data to prioritize learning on high-impact classes adding additional classes incrementally based on performance metrics.

In some embodiments, the model uses phased training methods that focus on subsets of products/UPCs selected based on recent sales data and the classification performance to minimize class overlap, thereby enhancing training adaptability and efficiency (i.e., incremental training strategy). The model uses top-view and bottom-view images in the training process to improve the model's robustness and adaptability to variable image qualities and lighting conditions (i.e., dual-view image utilization.

In other embodiments, the model uses a progressive class inclusion system that adds new classes based on performance metrics for continuous adaptability to store inventory changes (i.e., dynamic class addition). The model implements a “RandAug” pre-processing to enhance the diversity and robustness of the image dataset and deal with overfitting (i.e., advanced data augmentation). The model utilizes down sampling to reduce the number of images in overrepresented products and oversampling to increase representation of underrepresented products to ensure adequate learning and improve model performance (i.e., balancing class distribution).

In other embodiments, the model resizes all images to uniform dimensions, such as 224×224 pixels, to maintain consistency in the dataset (i.e., image standardization). However, the system is not limited to resizing images to 224×224 pixels. The images can be resized to any uniform or standardized size.

The model reduces the learning rate during training epochs to fine-tune model weights and enhance convergence using a dynamic learning rate scheduler. The model leverages real-time sales data to prioritize learning on high-impact classes to generate high sales (i.e., targeted initial training). The model adds more classes based on their performance metrics to incrementally boost the model's accuracy and adaptability (i.e., progressive class expansion).

Alternatively, or in addition to the other examples described herein, examples include any combination of the following:
select a set of next highest impact items from the plurality of items using the set of configurable performance criteria;
extract a second subset of the dual-view image data associated with the set of next highest items, the second subset of the dual-view image data comprising dual-view images of each item in the set of next highest impact items, the dual-view images comprising top view images and bottom view images;
generate a third set of training data having the higher ratio of the top view images of the set of high impact items and a fourth set of training data having the higher ratio of bottom view images of the set of high impact items;
re-train the item recognition model iteratively using the third set of training data during a third training phase and the fourth set of training data during a fourth training phase, wherein the trained item recognition model automatically identifies item IDs associated with items in the set of high impact items and the set of next highest impact items appearing in images generated by the plurality of image capture devices with greater accuracy;
wherein a threshold number of images of each item in the set of high impact items are selected for inclusion in the subset of the dual-view image data;
responsive to a number of available images of an item in the set of high impact items falling below the threshold number, apply image augmentation to the number of available images;
create additional images of the item using the image augmentation until the number of available images and the additional images equals the threshold number of images for inclusion in the subset of the dual-view image data;
reduce a learning rate during training epochs, using a dynamic learning rate schedule, to fine-tune a set of weights of the item recognition model, wherein fine-tuning enhances item recognition accuracy;
retrieve historical item data generated during a predetermined time-period;
analyze the historical using the set of configurable performance criteria to select high impact items for inclusion in the set of high impact items;
resize images in the dual-view image data set to uniform dimensions prior to use in training the item recognition model;
wherein the set of high performance items is a first class of items;
incrementally train the item recognition model with progressive class expansion, wherein the item recognition model is trained incrementally using dual-view image data corresponding to different item classes over time, wherein the item recognition model is initially trained using the dual-view image data corresponding to the first class of items; and
wherein the item recognition model is subsequently trained using the dual-view image data corresponding to a second class of items followed by training of the item recognition model using the dual-view image data corresponding to a third class of items.

At least a portion of the functionality of the various elements in FIG. 1, FIG. 2, FIG. 3, FIG. 4, and FIG. 5 can be performed by other elements in FIG. 1, FIG. 2, FIG. 3, FIG. 4, and FIG. 5, or an entity (e.g., processor 106, web service, server, application program, computing device, etc.) not shown in FIG. 1, FIG. 2, FIG. 3, FIG. 4, and FIG. 5.

In some examples, the operations illustrated in FIG. 6, FIG. 7, FIG. 8, FIG. 9, FIG. 10, and FIG. 11 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of training an item recognition model using dual-view image data, the method comprising generating, by a plurality of image capture devices associated with an archway truss device, the dual-view image data associated with a plurality of items, the dual-view image data comprising a plurality of images of the plurality of items, the dual-view image data comprising top view images generated by a first image capture device associated with a top portion of the archway truss device and bottom view images generated by a second image capture device associated with a bottom portion of the archway truss device; selecting a set of high impact items from the plurality of items using a set of configurable performance criteria; extracting a subset of dual-view image data associated with the set of high impact items from the dual-view image data; generating a first set of training data having a higher ratio of top view images of the set of high impact items and a second set of training data having a higher ratio of bottom view images of the set of high impact items; and training the item recognition model using the first set of training data during a first training phase and the second set of training data during a second training phase, wherein the trained item recognition model automatically identifies an item ID associated with each high impact item in the set of high impact items appearing in images generated by the plurality of image capture devices with greater accuracy.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for training an item recognition model using multi-view image data with balanced class distribution. For example, the elements illustrated in FIG. 1, FIG. 2, FIG. 3, FIG. 4, and FIG. 5, such as when encoded to perform the operations illustrated in FIG. 6, FIG. 7, FIG. 8, FIG. 9, FIG. 10, and FIG. 11, constitute exemplary means for generating, by a plurality of image capture devices associated with an archway truss device, the dual-view image data associated with a plurality of items, the dual-view image data comprising a plurality of images of the plurality of items, the dual-view image data comprising top view images generated by a first image capture device associated with a top portion of the archway truss device and bottom view images generated by a second image capture device associated with a bottom portion of the archway truss device; exemplary means for selecting a set of high impact items from the plurality of items using a set of configurable performance criteria; exemplary means for extracting a subset of dual-view image data associated with the set of high impact items from the dual-view image data; exemplary means for generating a first set of training data having a higher ratio of top view images of the set of high impact items and a second set of training data having a higher ratio of bottom view images of the set of high impact items; and exemplary means for training the item recognition model using the first set of training data during a first training phase and the second set of training data during a second training phase, wherein the trained item recognition model automatically identifies an item identifier (ID) associated with each high impact item in the set of high impact items appearing in images generated by the plurality of image capture devices with greater accuracy.

Other non-limiting examples provide one or more computer storage devices having a first computer-executable instructions stored thereon for providing incremental training of image recognition models using multi-view image data with balanced class distribution. When executed by a computer, the computer performs operations including generating, by a plurality of image capture devices associated with an archway truss device, the dual-view image data associated with a plurality of items, the dual-view image data comprising a plurality of images of the plurality of items, the dual-view image data comprising top view images generated by a first image capture device associated with a top portion of the archway truss device and bottom view images generated by a second image capture device associated with a bottom portion of the archway truss device; selecting a set of high impact items from the plurality of items using a set of configurable performance criteria; extracting a subset of dual-view image data associated with the set of high impact items from the dual-view image data; generating a first set of training data having a higher ratio of top view images of the set of high impact items and a second set of training data having a higher ratio of bottom view images of the set of high impact items; and training the item recognition model using the first set of training data during a first training phase and the second set of training data during a second training phase.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of′ ”only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for item recognition model training with dual-view image data, the system comprising:
a processor; and
a computer-readable medium storing instructions that are operative upon execution by the processor to:
obtain the dual-view image data associated with a plurality of items, the dual-view image data comprising a plurality of images generated by a plurality of image capture devices, the dual-view image data comprising top view images generated by a first image capture device and bottom view images generated by a second image capture device;
select a set of high impact items from the plurality of items using a set of configurable performance criteria;
filter the dual-view image data to extract a subset of the dual-view image data associated with the set of high impact items, the subset of the dual-view image data comprising a set of top view images of each item in the set of high impact items and a set of bottom view images of each item in the set of high impact items;
generate a first set of training data having a higher top view image ratio and a second set of training data having a higher bottom view image ratio; and
train the item recognition model using the first set of training data during a first training phase and the second set of training data during a second training phase, wherein the trained item recognition model automatically identifies an item identifier (ID) associated with each high impact item in the set of high impact items appearing in images generated by the plurality of image capture devices with greater accuracy.

2. The system of claim 1, wherein the instructions are further operative to:
select a set of next highest impact items from the plurality of items using the set of configurable performance criteria;
extract a second subset of the dual-view image data associated with the set of next highest items, the second subset of the dual-view image data comprising dual-view images of each item in the set of next highest impact items, the dual-view images comprising top view images and bottom view images;
generate a third set of training data having the higher ratio of the top view images of the set of high impact items and a fourth set of training data having the higher ratio of bottom view images of the set of high impact items; and
re-train the item recognition model iteratively using the third set of training data during a third training phase and the fourth set of training data during a fourth training phase.

3. The system of claim 1, wherein a threshold number of images of each item in the set of high impact items are selected for inclusion in the subset of the dual-view image data, and wherein the instructions are further operative to:
responsive to a number of available images of an item in the set of high impact items falling below the threshold number of images, apply image augmentation to the number of available images; and
create additional images of the item using the image augmentation until the number of available images and the additional images equals the threshold number of images for inclusion in the subset of the dual-view image data.

4. The system of claim 1, wherein the instructions are further operative to:
reduce a learning rate during training epochs, using a dynamic learning rate schedule, to fine-tune a set of weights of the item recognition model, wherein fine-tuning enhances item recognition accuracy.

5. The system of claim 1, wherein the instructions are further operative to:
retrieve historical item data generated during a predetermined time-period; and
analyze the historical using the set of configurable performance criteria to select high impact items for inclusion in the set of high impact items.

6. The system of claim 1, wherein the instructions are further operative to:
resize at least one image in the dual-view image data set to uniform dimensions prior to use in training the item recognition model.

7. The system of claim 1, wherein the set of high performance items is a first class of items, and wherein the instructions are further operative to:
incrementally train the item recognition model with progressive class expansion, wherein the item recognition model is trained incrementally using dual-view image data corresponding to different item classes over time, wherein the item recognition model is initially trained using the dual-view image data corresponding to the first class of items, and wherein the item recognition model is subsequently trained using the dual-view image data corresponding to a second class of items followed by training of the item recognition model using the dual-view image data corresponding to a third class of items.

8. A method for item recognition model training with dual-view image data, the method comprising:
generating, by a plurality of image capture devices associated with an archway truss device, the dual-view image data associated with a plurality of items, the dual-view image data comprising a plurality of images of the plurality of items, the dual-view image data comprising top view images generated by a first image capture device associated with a top portion of the archway truss device and bottom view images generated by a second image capture device associated with a bottom portion of the archway truss device;
selecting a set of high impact items from the plurality of items using a set of configurable performance criteria;
extracting a subset of dual-view image data associated with the set of high impact items from the dual-view image data;
generating a first set of training data having a higher ratio of top view images of the set of high impact items and a second set of training data having a higher ratio of bottom view images of the set of high impact items; and
training the item recognition model using the first set of training data during a first training phase and the second set of training data during a second training phase.

9. The method of claim 8, further comprising:
selecting a set of next highest impact items from the plurality of items using the set of configurable performance criteria;
extracting a second subset of the dual-view image data associated with the set of next highest items, the second subset of the dual-view image data comprising dual-view images of each item in the set of next highest impact items, the dual-view images comprising top view images and bottom view images;
generating a third set of training data having the higher ratio of the top view images of the set of high impact items and a fourth set of training data having the higher ratio of bottom view images of the set of high impact items; and
re-training the item recognition model iteratively using the third set of training data during a third training phase and the fourth set of training data during a fourth training phase, wherein the trained item recognition model automatically identifies item IDs associated with items in the set of high impact items and the set of next highest impact items appearing in images generated by the plurality of image capture devices with greater accuracy.

10. The method of claim 8, further comprising:
responsive to a number of available images of an item in the set of high impact items falling below a threshold number, applying image augmentation to the number of available images; and
creating additional images of the item using the image augmentation until the number of available images and the additional images equals the threshold number of images for inclusion in the subset of the dual-view image data.

11. The method of claim 8, further comprising:
reducing a learning rate during training epochs, using a dynamic learning rate schedule, to fine-tune a set of weights of the item recognition model, wherein fine-tuning enhances item recognition accuracy.

12. The method of claim 8, further comprising:
retrieving historical item data generated during a predetermined time-period; and
analyzing the historical using the set of configurable performance criteria to select high impact items for inclusion in the set of high impact items.

13. The method of claim 8, further comprising:
resizing at least one image in the dual-view image data set to uniform dimensions prior to use in training the item recognition model.

14. The method of claim 8, further comprising:
incrementally training the item recognition model with progressive class expansion, wherein the item recognition model is trained incrementally using dual-view image data corresponding to different item classes over time, wherein the item recognition model is initially trained using the dual-view image data corresponding to a first class of items, and wherein the item recognition model is subsequently trained using the dual-view image data corresponding to a second class of items followed by training of the item recognition model using the dual-view image data corresponding to a third class of items.

15. One or more computer storage devices having computer-executable instructions stored thereon, which, upon execution by a computer, cause the computer to perform operations comprising:
generating, by a plurality of image capture devices associated with an archway truss device, dual-view image data associated with a plurality of items, the dual-view image data comprising a plurality of images of the plurality of items, the dual-view image data comprising top view images generated by a first image capture device associated with a top portion of the archway truss device and bottom view images generated by a second image capture device associated with a bottom portion of the archway truss device;
selecting a set of high impact items from the plurality of items using a set of configurable performance criteria;
extracting a subset of dual-view image data associated with the set of high impact items from the dual-view image data;
generating a first set of training data having a higher ratio of top view images of the set of high impact items and a second set of training data having a higher ratio of bottom view images of the set of high impact items; and
training an item recognition model using the first set of training data during a first training phase and the second set of training data during a second training phase, wherein the trained item recognition model automatically identifies an item ID associated with each high impact item in the set of high impact items appearing in images generated by the plurality of image capture devices with greater accuracy.

16. The one or more computer storage devices of claim 15, wherein the operations further comprise:
selecting a set of next highest impact items from the plurality of items using the set of configurable performance criteria;
extracting a second subset of the dual-view image data associated with the set of next highest items, the second subset of the dual-view image data comprising dual-view images of each item in the set of next highest impact items, the dual-view images comprising top view images and bottom view images;
generating a third set of training data having the higher ratio of the top view images of the set of high impact items and a fourth set of training data having the higher ratio of bottom view images of the set of high impact items; and
re-training the item recognition model iteratively using the third set of training data during a third training phase and the fourth set of training data during a fourth training phase, wherein the trained item recognition model automatically identifies item IDs associated with items in the set of high impact items and the set of next highest impact items appearing in images generated by the plurality of image capture devices with greater accuracy.

17. The one or more computer storage devices of claim 15, wherein the operations further comprise:
applying image augmentation to a number of available images of an item in the plurality of items; and
creating additional images of the item using the image augmentation until the number of available images and the additional images equals a minimum threshold number of images for inclusion in the subset of the dual-view image data.

18. The one or more computer storage devices of claim 15, wherein the operations further comprise:
reducing a learning rate during training epochs, using a dynamic learning rate schedule, to fine-tune a set of weights of the item recognition model, wherein fine-tuning enhances item recognition accuracy.

19. The one or more computer storage devices of claim 15, wherein the operations further comprise:
retrieving historical item data generated during a predetermined time-period; and
analyzing the historical using the set of configurable performance criteria to select high impact items for inclusion in the set of high impact items.

20. The one or more computer storage devices of claim 15, wherein the operations further comprise:
resizing at least one image in the dual-view image data set to uniform dimensions prior to use in training the item recognition model.
